(19) United States
(12) Patent Application Publication
(10) Pub. No.: US 2012/0054004 A1
(43) Pub. Date: Mar. 1, 2012

(54) INVITATIONAL CONTENT RECOMMENDATION ENGINE

(75) Inventors: Eswar Priyadarshan, West Roxbury, MA (US); Kenley Sun, Cambridge, MA (US); Dan Marius Grigorovici, Pleasanton, CA (US); Ravikiran Chittari, Cupertino, CA (US); Jayasurya Vadrevu, Lexington, MA (US); Jeffery M. Banister, San Jose, CA (US)

(73) Assignee: Apple Inc., Cupertino, CA (US)

(21) Appl. No.: 12/873,283

(22) Filed: Aug. 31, 2010

(51) Int. Cl. G06Q 30/00; G06Q 10/00

(52) U.S. Cl. 705/14.4

(57) ABSTRACT

Systems and methods are provided for booking and managing electronic campaigns. In particular, electronic campaigns are booked by obtaining a correlation between campaign input parameters for the campaign, campaign output characteristics for the campaign, and network output characteristics of network elements affected or impacted by the campaign. The correlation can then be used to identify sets of values for the input parameters that result in the various output characteristics meeting some criteria and one of the sets can thereafter be used to book an electronic campaign. At a later time, if the actual values for the various output parameters fail to meet corresponding criteria, the correlation can be updated to identify and select a new set of campaign input parameter values for the electronic campaign.

### FIELD

The following relates to electronic content delivery and more specifically relates to systems and methods for predicting the performance of contents and contexts based on a performance history of users.

### BACKGROUND

Computer applications, websites, or other electronic content including offers for products and services generally require a user to explicitly select and/or interact with one or more portions of the content being presented to generate a conversion (e.g., completion of a sale or purchase, submission of information to a content provider, causing delivery of additional information to the user or any other pre-defined response for the content). For example, an advertisement for a product or service can require the user to select the advertisement content and navigate to the online store offering the product for sale. At the online store, the user can then enter information to purchase or obtain additional information regarding the product or service.

In many types of electronic content maintained by (primary) content providers, invitational content (i.e., the portions of the content offering products and services) are generally provided by other (secondary) content providers. The combination of content from the primary content providers and invitational content from the secondary content providers may be done directly by the primary content providers or via an agent. Accordingly, the invitational content in these portions varies over time, depending on the various arrangements between the primary content provider and the various secondary content providers. For example, each of the secondary content providers may arrange for a number of impressions of their invitational content. Further, secondary content providers may also arrange to have their invitational content associated only with a particular context.

Secondary content providers typically select the primary content providers for their invitational content using a number of different approaches. For example, secondary content provider may select primary content providers which are known to be associated with content similar or related to their invitational content. Alternatively, secondary content providers can select primary content providers that are known to be associated with the target audience for the invitational content. Absent such knowledge, secondary content providers typically rely on random targeting.

### SUMMARY

The present technology provides systems and methods for planning and managing electronic campaigns. In particular, the present technology utilizes a history of the performance and configuration of previous electronic campaigns to determine the correlation between input parameters and output characteristics associated with the request and a content delivery system. Thereafter the correlation data can be used to determine a set of input parameters for booking an electronic campaign. In the various embodiments, the input parameters are selected such that criteria specified in the request and criteria specified by the content delivery system and/or other network elements are met.

A first aspect of the present technology is directed to the booking process. The booking process begins with the receipt of a campaign request from a user terminal associated with a secondary content provider. The campaign request can specify criteria for selecting campaign input parameters, such as the requested inventory atoms or slots, the types of invitational content to be delivered, or any other non-financial or non-performance goals for the campaign. The request can also include criteria for campaign output parameters, identifying the financial or performance goals for the campaign.

Responsive to this request, a correlation can be obtained that identifies the relationship between values for the campaign input parameters, the campaign output characteristics, and network output characteristics that identify the financial or performance goals of the content delivery system, the primary content providers, or any other network elements affected by the electronic campaign. The correlation can then be used to generate sets of values that meet criteria for the campaign input characteristics, the campaign output characteristics, and the network output characteristics. A secondary content provider can then select one of these sets of values to deploy or book the electronic campaign.

A second aspect of the present technology is directed to updating booked electronic campaigns. In a dynamic environment, such as that of a content delivery system, it is possible that the set of input parameter values that were used to book an electronic campaign are no longer valid. Accordingly, in such cases, these values can be updated to reflect these changes. This monitoring process can include obtaining actual values for the campaign output characteristics and the network output characteristics. Thereafter, if at least some of the actual values diverge from target values for these characteristics, the electronic campaign can be updated. In particular, an updated correlation is obtained and is thereafter used to select a new set of values.

In the various embodiments, the presentation and/or selection of the sets of values for the input parameters can be based on a ranking or order. In particular, each of the sets of values can be associated with a score or rank with respect to the system output characteristics. Thus, the values for input parameters can be selected and/or presented such that the goals of the content delivery system, the primary content providers, or any other network elements affected by the electronic campaign are primarily considered.

### BRIEF DESCRIPTION OF THE DRAWINGS

FIG. 1 illustrates an example computing device;

FIG. 2 illustrates an exemplary system embodiment;

FIG. 3 is a schematic diagram of an inventory space;

FIG. 4 is a detailed schematic of the database processing module in FIG. 2;

FIG. 5 is a flowchart of steps in an exemplary method for processing a request for an electronic campaign; and

FIG. 6 is a flowchart of steps in an exemplary method for monitoring and updating booked electronic campaigns; and

FIG. 7 is an exemplary configuration for a user interface.

### DESCRIPTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the spirit and scope of the disclosure.

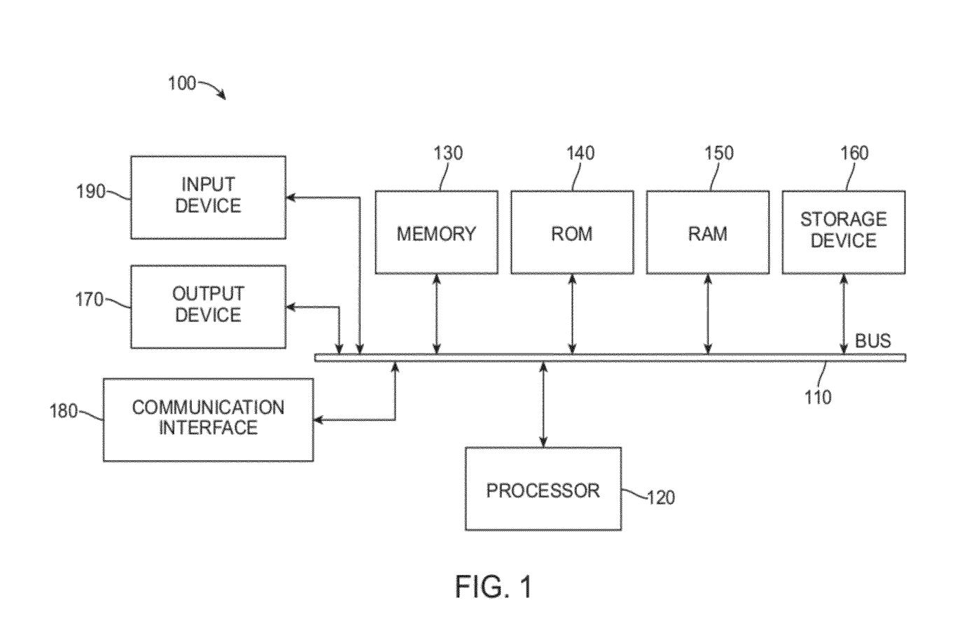

With reference to FIG. 1, a general-purpose computing device 100 which can be portable or stationary is shown, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the system may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a large computer server.

Although the exemplary environment described herein employs a hard disk, it should be appreciated by those skilled in the art that other types of computer readable media which can store data that is accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can also be one or more of a number of output mechanisms known to those of skill in the art. For example, video output or audio output devices which can be connected to or can include displays or speakers are common. Additionally, the video output and audio output devices can also include specialized processors for enhanced performance of these specialized functions. In some instances, multimodal systems enable a user to provide multiple types of input to communicate with the computing device 100. The communications interface 180 generally governs and manages the user input and system output. There is no restriction on the disclosed methods and devices operating on any particular hardware arrangement and therefore the basic features may easily be substituted for improved hardware or firmware arrangements as they are developed. For clarity of explanation, the illustrative system embodiment is presented as including individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) for storing software performing the operations discussed below, and random access memory (RAM) for storing results. Very large scale integration (VLSI), field-programmable gate array (FPGA), and application specific integrated circuit (ASIC) hardware embodiments may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

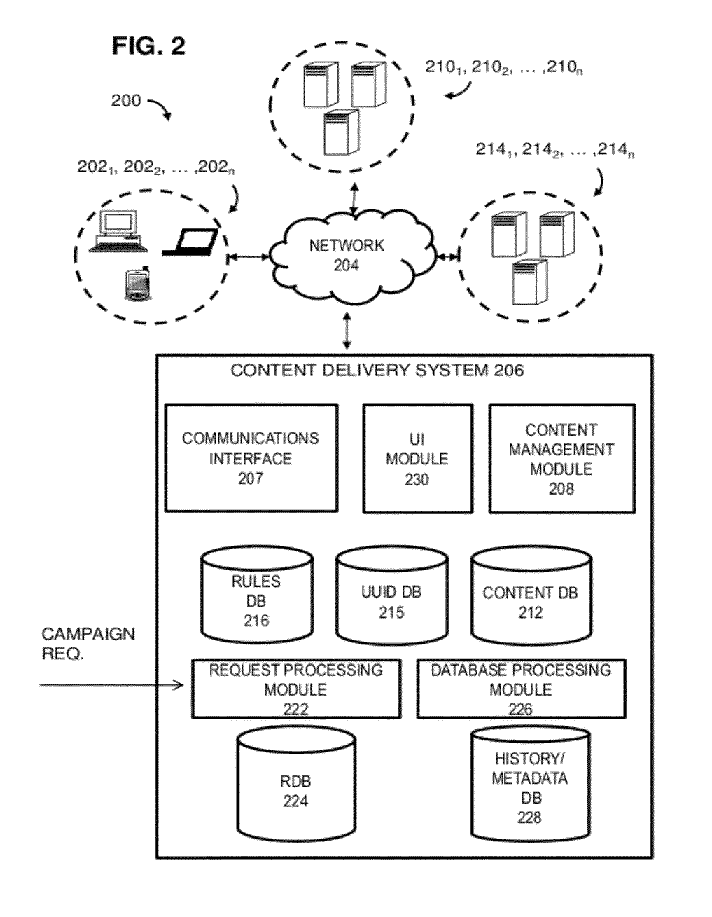

The present system and method is particularly useful for managing an inventory of atoms from one or more primary content providers for use by multiple content providers. A system 200 is illustrated in FIG. 2 wherein electronic devices communicate via a network for purposes of exchanging content and other data. In some embodiments, the present system and method are carried out on a local area network such as that illustrated in FIG. 2. However, the present principles are applicable to a wide variety of network configurations that facilitate the intercommunication of electronic devices.

In system 200, invitational content is delivered to user terminals 202₁ . . . 202ₙ (collectively “202”) connected to a network 204 by direct and/or indirect communications with a content delivery system 206. In particular, the content delivery system 206 receives a request for a content package of electronic-invitational content, such as a web page, an application, a game, or media, etc., from one of user terminals 202. In the various embodiments, one or more types of invitational content can be combined in a content package. The invitational content can include text, graphics, audio, video, executable code or any combination thereof. In some embodiments, the invitational content can be associated with a product or can directly or indirectly advertise a product. In some embodiments, the content package can be configured to replace or update invitational content in a content package already delivered to the user terminal.

Further, the invitational content can be active invitational content. That is, invitational content that is designed to primarily elicit a pre-defined response from the user. For example, active invitational content can include one or more types of advertisements configured to be clicked upon, solicit information, or be converted by the user into a further action, such as a purchase or download of the advertised item. However, invitational content can also include passive invitational content. That is, invitational content that is designed to primarily inform the user. In some cases, passive invitational content can include information that can lead or direct users to active invitational content. Additionally, the invitational content can be dynamic invitational content. That is, invitational content that varies over time or that varies based on user interaction with the invitational content. However, the various embodiments are not limited in this regard and the invitational content can be static invitational content that does not vary over time or that varies based on user interaction. In the various embodiments, an invitational content in a content package can be static or dynamic and active or passive. Further, various types of invitational content can be combined in a same content package.

After receiving the request for invitational content, the content delivery system 206 selects the invitational content in response to the request and transmits the assembled invitational content to the requesting one of user terminals 202. In some embodiments, the server has preselected the invitational content before the request is received. Thereafter, the server assembles a content package of invitational content and causes the content package to be delivered to the user. The content delivery system can include a communications interface 207 to facilitate communications with the user terminals 202 and any other components familiar to those of ordinary skill in the art.

The content delivery system 206 includes a content management module 208 that facilitates generation of the assembled content package that includes time-varying content, such as an advertisement. Specifically, the content management module can combine content from one or more primary content providers 210₁ . . . 210ₙ₂ (collectively “210”) and content from one or more secondary content providers 214₁ . . . 214ₙ₃ (collectively “214”) to generate the assembled content package for the user terminals 202. For example, in the case of a web page being delivered to a requesting one of user terminals 202, the content management module 208 can assemble a content package by requesting the data for the web page from one of the primary content providers 210 maintaining the web page. For the time varying content on the web page provided by the secondary content providers 214, the content management module 208 can request the appropriate data according to the arrangement between the primary and secondary content providers 210 and 214.

Although, primary and secondary providers 210, 214 are presented herein as separate entities, this is for illustrative purposes only. In some cases, the primary and secondary providers 210, 214 can be the same entity. Thus, a single entity may define and provide both the static and the time-varying content.

In some embodiments, the content management module 208 can be configured to request that the data be sent directly from content providers 210 and 214. In other embodiments a cached arrangement can also be used to improve performance of the content delivery system 206 and improve overall user experience. That is, the content delivery system 206 can include a content database 212 for locally storing or caching content maintained by content providers 210 and 214. The data in the content database 212 can be refreshed or updated on a regular basis to ensure that the content in the database 212 is up to date at the time of a request from a user terminal. However, in some cases, the content management module 208 can be configured to retrieve data directly from content providers 210 and 214 if the metadata associated with the data in content database 212 appears to be outdated or corrupted.

In the various embodiments, the one or more databases described herein can be implemented using any type of data structures. Such data structures include, but are not limited to data structures for relational databases, key/value stores, graph databases, hierarchical databases, and distributed or columnar stores. Accordingly, although the various embodiments described herein may refer to specific data structures in some embodiments, in other embodiments such data structures can be substituted for any other type of database structure.

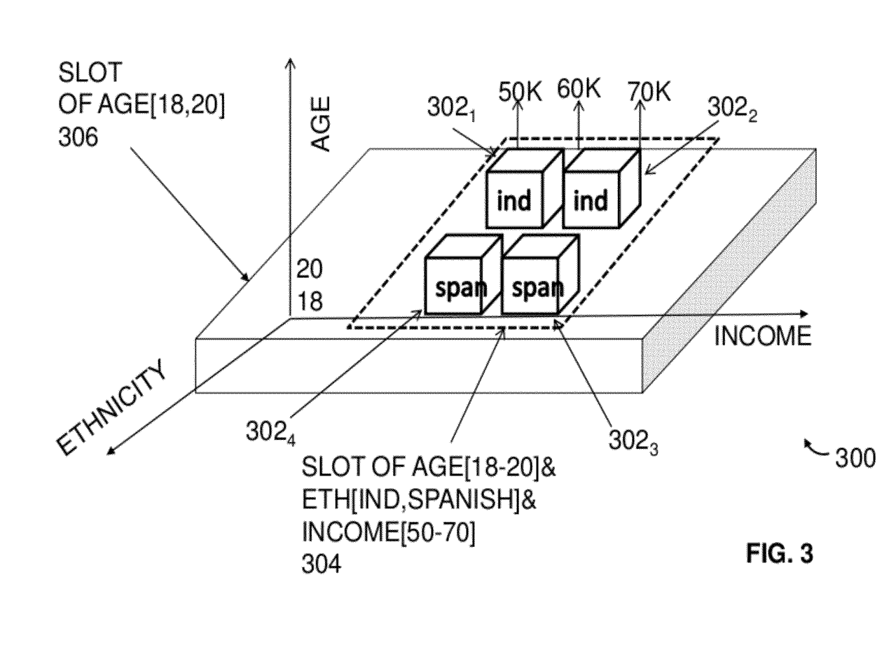

In the various embodiments, the content space provided by primary content providers 210 is managed as an inventory or collection of atoms defining an inventory space or region in a k-dimensional space of atoms, where each of the k dimensions is associated with one of a plurality of traffic segment characteristics. In the various embodiments, the k dimensions can include both orthogonal and non-orthogonal dimensions. That is, some of the k dimensions can overlap or can be related in some aspect. For example, if separate dimensions are specified for city and state, these dimensions are non-orthogonal. Each atom represents a portion of traffic associated with a specific set of values for the traffic segment characteristics in the k-dimensional space. For example, an atom can represent a fixed number of impressions for a particular segment. The inventory space will consist of one or more portions of the k-dimensional space depending on the segment characteristics associated with the content space available from the primary content providers 210. Accordingly the content delivery system 206 can manage an electronic campaign for one or more secondary content providers 214 based on the one or more segment characteristics of interest to each of the secondary content providers 214. This is conceptually illustrated in FIG. 3.

FIG. 3 is a schematic diagram of an inventory space 300. As shown in FIG. 3, the space 300 is defined by demographic characteristics, specifically age, income, and ethnicity. Thus, each atom in space 300 is associated with an amount of traffic, a specific ethnicity, a specific age or age group, and a specific income or income group. For example, each of atoms 302₁, 302₂, 302₃, and 302₄ (collectively 302) is an amount of traffic (e.g., n impressions) associated with one of a Spanish or Indian ethnicity, one of a $50,000-$60,000 or a $60,000-$70,000 income bracket, an age range between 18 and 20.Thus, one of secondary content providers 214 wishing to deliver n impressions to Spanish and Indian users aged between 18 and 20 and having an income between $50,000 and $70,000, would request to reserve or book a slot 304 consisting of atoms 302. However, a larger slot of atoms could also be specified, such as slot 306 consisting of all atoms associated with users aged 18-20.

Although the space 300 in FIG. 3 is defined in terms of a few demographic segment characteristics, other segment characteristics can also be used. For example, an inventory space can include channel characteristics, spatial-temporal characteristics, behavioral characteristics, and demographic characteristics, to name a few. Channel characteristics can define the specific delivery channel being used to deliver a content package. For example, channel characteristics can include a type of electronic content, a type of device or user terminal, a carrier or network provider, or any other characteristic that defines a specific delivery channel for the content. Spatial-temporal characteristics can define a location, a date, a time, or any other characteristic that defines a geographic location and/or a time for delivery of the content. Demographic characteristics can define characteristics of the users targeted by the content or associated with the content. For example, demographic characteristics can include age, income, and ethnicity, as shown in FIG. 3, but can also include other demographic characteristics such as gender, occupation, or any other user characteristics. Behavioral characteristics can define user behaviors for one or more different types of content, separately or in combination with any other contextual characteristics. That is, different behavioral characteristics may be associated with different channel, demographic, or spatial temporal characteristics. For example, users may be associated with higher conversion or response rates for some types of delivery channels.

In FIG. 3, the atoms 302 are shown as defining the entire traffic for each combination of segment characteristics for purposes of illustration only. In the various embodiments, any number of atoms, each defining an amount of traffic, can be specified for each combination of segment characteristics. For example, referring to the example in FIG. 3 above, each of atoms 302 can represent a collection of m sub-atoms, such that each of the m sub-atoms represents an amount of the total traffic for the combination of segment characteristics. In the case of the n impressions described above for atoms 302, the m sub-atoms for each of atoms 302 can be each associated with an amount of n/m impressions. Alternatively, the atoms 302 can be managed as being partially booked. In such configurations, as inventory slots are fulfilled, the metadata indicates each of the inventory slots it is associated with and the amount of traffic for each of the slots.

In FIG. 3, the inventory space 300 is shown as being continuous. However, in the various embodiments, an inventory space of inventory atoms can be continuous or discontinuous. For example, if a first primary content provider is associated with users with incomes between $25,000 and $50,000, a second primary content provider is associated with users with incomes between $70,000 and $100,000, and no other primary content providers are available, then the inventory space defined by these two primary content providers would exclude any atom associated with incomes between $50,000 and $70,000. As a result, the inventory space would be discontinuous. Although the above example discusses a single segment characteristic causing the discontinuity, in the various embodiments any number of segment characteristics can cause discontinuities in the inventory space.

It is worth noting that although the above-mentioned examples are described in terms of the inventory atoms associated with the primary content providers 210, the inventory atoms defining the inventory space can be based on segment characteristics associated with other components or elements of system 200. For example, the primary content providers can have content and/or content space associated with segment characteristics in multiple dimensions and thus defines a first set of dimensions and segment characteristic values therein for the inventory space. However, the users and user terminal, based on their characteristics and behavior, can also be associated with segment characteristics in multiple dimensions. Thus, a second set of dimensions and values therein for the inventory space can be defined. Additionally, the content delivery system may be configured to consider with specific segment characteristics along multiple dimensions for the secondary content providers. Thus, a third set of dimensions and values therein for the inventory space can be defined. As a result, the inventory space is therefore defined by the atoms at the intersection of these different sets of dimensions and values.

In the various embodiments, the content delivery 206 can also include a unique user identifier (UUID) database 215 that can be used for managing sessions with the various user terminal devices 202. The UUID database 215 can be used with a variety of session management techniques. For example, the content delivery system 206 can implement an HTTP cookie or other conventional session management methods (e.g., IP address tracking, URL query strings, hidden form fields, window name tracking, authentication methods, and local shared objects) for user terminals 202 connected to content delivery system 206 via a substantially persistent network session. However, other methods can be used as well. For example, in the case of mobile devices or other types of user terminals connecting using multiple or non-persistent network sessions, multiple requests for content from such devices may be assigned to a same entry in the UUID database 215. Such an assignment can be provided by analyzing requesting device attributes in order to determine whether such requests can be attributed to a same device. Such attributes can include device or group-specific attributes.

As described above, one aspect of the present technology involves the gathering and use of data available from various sources to improve the delivery of advertisements or any other content that may be of interest to users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, or any other identifying information.

The present disclosure recognizes that the use of such personal information data in the present technology can be used to the benefit of users. For example, the personal information data can be used to better understand user behavior, facilitate and measure the effectiveness of advertisements, applications, and delivered content. Accordingly, use of such personal information data enables calculated control of the delivered content. For example, the system can reduce the number of times a user receives a given ad or other content and can thereby select and deliver content that is more meaningful to users. Such changes in system behavior improve the user experience. Further, other uses for personal information data that benefit the user are also contemplated by the present disclosure.

The present disclosure further contemplates that the entities responsible for the collection, analysis, disclosure, transfer, storage, or other use of such personal information data should implement and consistently use privacy policies and practices that that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after the informed consent of the users. Additionally, such entities would take any needed steps for safeguarding and securing access to such personal information data and ensuring that others with access to the personal information data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for advertisement delivery services. In yet another example, users can configure their devices or user terminals to prevent storage or use of cookies and other mechanisms from which personal information data can be discerned. The present disclosure also contemplates that other methods or technologies may exist for blocking access to their personal information data.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

As described above, content maintained by the content providers 210 and 214 can be combined according a predefined arrangement between the two content providers, which can be embodied as a set of rules. In an arrangement where the content delivery system assembles the content package from multiple content providers, these rules can be stored in a rules database 216 in content delivery system 206 and content management module 208 can be configured to assemble the content package for user terminals 202 based on these rules. The rules can specify how to select content from secondary content providers 214 and the primary content providers 210 in response to a request from one of user terminals 202. For example, in the case of a web page maintained by one of primary providers 210 and including variable advertisement portions, the rules database 216 can specify rules for selecting one of the secondary providers 214. The rules can also specify how to select specific content from the selected one of secondary providers 214 to be combined with the content provided by one of primary providers 210. Once assembled, the assembled content package can be sent to a requesting one of user terminals. However, the content package is not limited to the content from content providers 210 and 214. Rather, the content package can include other data generated at the content delivery system 206.

In most content delivery environments, such as that of system 200, the number and type of providers 210 and 214 are generally not static. For example, the number of primary content providers 210 and the amount and type of space they provide for second content providers 214 can vary over time. Further, the number of secondary content providers 214 can vary over time, as well as the amount and types of space they require from primary content providers 210. Further, the types of user and user terminals of interest to the secondary content providers 214 can also vary over time. As a result, planning, specifying, and/or adjusting arrangements between the content providers 210 and 214 can quickly become complicated in such a dynamic environment.

For example, it can be difficult to plan an electronic campaign in such an environment, since the complexity of the environment can require considering a large number of parameters to book a campaign. In particular, because of the large number of parameters, it can be difficult to determine which set of input parameter values will result in a campaign that provides the best results for the secondary content provider. Additionally, the increasing complexity of such environments also makes it increasingly difficult for content delivery systems to book and manage electronic campaigns to concurrently provide best results for the content delivery system, primary content providers, or any other network elements. That is, while a particular arrangement may satisfy the needs of the electronic campaign, such an arrangement may operate contrary to the goals and/or requirements of a content delivery system, primary content providers, and other network elements being affected by the deployment of an electronic campaign. However, ascertaining when such issues come up can be difficult.

The various embodiments therefore provide systems and methods for improving processing of requests for electronic campaigns and management of active electronic campaigns in such dynamic environments. A first aspect of the present technology provides systems and methods for planning and booking of electronic advertisement campaigns in response to campaign requests from secondary content providers. A second aspect of the present technology provides systems and methods for managing active campaigns in a dynamic environment. In the present technology, the electronic campaigns are booked and updated in order to not only meet the performance goals of the secondary content provider, but also the performance goals of the content delivery system, primary content providers, and other network elements affected by the electronic campaign.

Referring back to FIG. 2, content delivery system 206 can include a request processing module 222 for booking and subsequently managing electronic campaigns. The request processing module 222 is operable to receive requests from users, in particular secondary content providers, i.e., advertisers, seeking to place their secondary content within the primary content being delivered to user terminals 202. In some embodiments, the campaign requests can be received from dedicated advertiser terminals that are communicatively coupled, directly or indirectly (via network 204), to the content delivery system 206. In other embodiments, the campaign requests can be received from user terminals 202 or any other component in system 200.

In the various embodiments, the requests can specify criteria for selecting values for campaign input parameters. That is, a range of values that specify how delivery of invitational content from the one of the secondary content providers 214 is to be performed, without regard to performance or cost. For example, the criteria for campaign input parameters can specify values for selecting inventory atoms and/or slots. In particular, a request can include atom or slot identifying information, such as segment characteristic information, as described above. The requests can also specify criteria defining acceptable values for campaign output characteristics. That is, criteria that specify a range of budgetary constraints, performance constraints, or any constraints related to any metrics of interest. For example, the criteria for the campaign output characteristics can specify target values for rate of return, return on investment, target click-thru rate (CTR), conversion rate, guaranteed number of impressions, revenue, margin, or any other performance metrics.

In the various embodiments, the term “range”, as used with respect to input parameters or output characteristics, can define a group or collection of values, consecutive or non-consecutive, or a single (i.e., fixed) value. Accordingly, a request can specify any number of values for each of the input parameters and output characteristics.

In response to such requests, the request processing module 222 can perform an evaluation based on data stored in a relational database (RDB) 224 and thereafter provide a list of sets of values for the campaign input parameters that can be used to fulfill the requests. In system 200, RDB 224 is maintained using a database processing module 226. Specifically, the database processing module 226 retrieves performance history and metadata from the history/metadata database 228 for invitational content previously delivered by the content delivery system 206 (delivered invitational content) to user terminals 202. In particular, campaign input parameters, campaign output characteristics, and network output characteristics for previously booked campaigns can be retrieved. Thereafter, the database processing module generates data for the RDB 224, including data entries associating values of campaign input parameters with values of campaign output parameters and network output parameters and indexing or relational model information for the data entries. The data in RDB 224 can then be used by request processing module 222 to process a campaign request. In particular, the request processing module can generate proposed sets of values for the campaign input parameters based on the data in the RDB 224. For example, if the data in RDB 224 is in a matrix or table formant, the request processing module 222 can use any data estimation methods to determine sets of values from a dataset. For example, the request processing module can use lookup methods and/or extrapolation methods to determine values.

In a conventional system, these proposed sets of values for the campaign input parameters would be selected and presented to the user based on the criteria for the campaign output parameters. However, the list in the present technology is not presented with solely the user request in mind. Rather, the list presented to the user is also based on criteria for values for network output characteristics. That is, criteria that specify a range of budgetary constraints, performance constraints, or any constraints related to any metrics of interest to the content delivery system 206, primary content providers 210, or any other network elements impacted by the proposed electronic campaign. In particular, at least one of the network output characteristics is used to order or limit the list presented to the user. As a result, users are presented with sets of values for the input parameters that satisfy not only the user's criteria, but the criteria defined for the network elements. Thereafter, the user can make a selection from this list.

Once the user's selection is received by the request processing module 222, the request processing module 222 can then specify and/or modify rules in rules database 216. The new and/or updated rules can then be used by content management module 208, as described above, for associating specific invitational content with one or more contexts.

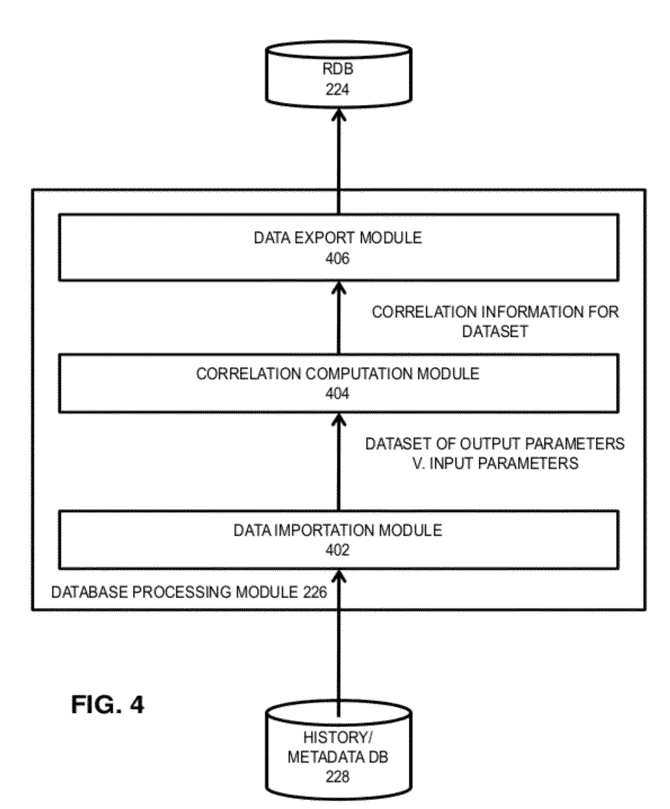

Referring now to FIG. 4, there is shown an exemplary configuration for the database processing module 226 in FIG. 2. As shown in FIG. 4, the database processing module 226 includes a data importation module 402 that retrieves and/or receives information from the history/metadata database 228, as described above. Specifically, the information for database processing module 226 includes information regarding the campaign input parameters specified for previously booked electronic campaigns. Further, the information also includes output characteristic data for these electronic campaigns. This not only includes the resulting values for the campaign output performance characteristics associated with the various electronic campaigns, but also the network output characteristics associated with the network elements affected or involved with delivery of invitational content for the electronic campaign. The database processing module 226 can then arrange the retrieved data in at least one dataset or matrix showing the resulting values for the campaign output characteristics and network output characteristics and associated campaign input parameters.

Once the input datasets or matrices are assembled at the data importation module 402, they can be passed to the correlation computation module 404 for processing. The correlation processing module 404 can perform several operations using this input dataset. In particular, the correlation processing module 404 can determine the n-way correlation between the variables (i.e., the campaign input parameters, the campaign output characteristics, and the network output characteristics). In the various embodiments, the n-way correlation can be stored in several ways at correlation computation module 404. For example, a correlation matrix can be assembled to show the correlation values between variables based on the input dataset. In another example, a correlation function can be stored that describes the relationship between each of the values based on the values in the input dataset. However, the various embodiments are not limited in this regard and any other methods for storing correlation information can be used.

In some instances, the input dataset may be incomplete. That is, there may be no data in the input dataset from data importation module 402 that associates some types of campaign input parameter data with some types of campaign output characteristic data and/or network output characteristic data. As a result, no data may be available for determining the correlation between values for some types of input parameters and values for some types of output characteristics. Accordingly, to address such issues, additional computations can be performed at the correlation computation module 404 to estimate the missing values.

In such configurations, the information from the history/metadata database 228 can be first processed by data importation module 402 to generate several sets of data. A first set can be an input/output rank data set. That is, for each of the campaign and network output characteristics specified in the performance history, ranking values for each set of campaign input parameter values with respect to each of these output characteristics can be generated. These values can be based on the actual values of the output characteristics in the performance history. For missing data a null value (i.e., 0) can be provided.

A second set of data consists of input parameter similarity values. That is, values indicating the similarity of each set of input parameter values with respect to each other set of the input parameter values in the performance history. A third and final set of data consists of output similarity values. That is, values indicating the similarity of an output characteristic in the performance history with respect to each other output characteristic in the performance history. These similarity values can be computed in a variety of ways.

These first, second, and third datasets can then be output as a single dataset. For example, in one embodiment, the datasets can be used to form first, second, and third matrices. The cross product of these matrices than then be computed to generate a single input matrix correlation computation module 404.

Once the input dataset or matrix is received by the correlation computation module 404, the correlation computation module 404 can identify clusters in the input dataset. That is, the correlation computation module 404 can identify the sets of campaign input parameter values and the output characteristics that are most closely related. In one embodiment, the clusters can be identified via a modified extended Fiedler method. However, other methods can be used to identify the clusters, such as k-means, nearest neighbor, or collaborative filtering techniques. In the modified extending Fielder method, the input matrix (I) from the data import module 402 is decomposed using a singular value decomposition (SVD) method (I=U*S*V^{T}). Thereafter, the signs in the singular vector matrices from the decomposition (U, V^{T}) can then be used to identify the clusters of sets of values of campaign input parameters and the clusters of output characteristics. The final clusters can then be determined, for example, by matching up the input parameter and output characteristics clusters to define a single cluster.

Typically, conventional signs-based SVD algorithms fail to provide a distance measure to assess goodness of the identified clusters and intra and inter-variability of the members of the identified clusters. Additionally, conventional signs-based SVD algorithms use a hard clustering method. That is, no overlapping clusters are allowed. However, in most circumstances, such overlaps are quite typical.

Accordingly, in the various embodiments, the conventional signs-based SVD algorithm is extended to select additional members for the clusters using a distance measure based on the moments of a probability distribution function. For example, in one embodiment, a Gaussian probability distribution function can be used. However, any type of probability distribution function can be used in the various embodiments. In operation, the members identified using the SVD algorithm (or any other clustering technique) is used to identify a probability distribution function. Thereafter, the first (mean μ) and second order (variance σ²) moments of the probability function are used to identify other members for the clusters. For example, the mean and the variance are used to generate a distance measure, such as μ±n×σ, where n>0 and is selected such that at least the members of the clusters in from the SVD are included. Such an approach therefore allows the use of the deterministic properties of the SVD method (definitive and reduced dimension space), while enhancing it to allow soft clustering. Further, performance metrics (statistical) are attached to each cluster, thus allowing us to assess their goodness. As a result, the output of at the correlation computation module 404 identifies the clusters and the statistical characteristics of each cluster, specifically the variance and mean for the clusters. The correlation computation module 404 can then forward the output matrices, the identified clusters, and the statistical characteristics of the clusters to a data export module 406 to assemble the correlation data.

It is worth noting that since Fiedler methods generally result in normalized matrices for identifying the clusters, the data associated with the input parameters and the output characteristics in the input matrix is effectively flattened, allowing this data to be directly combined and a single distance measure to be used for campaign input parameter data, campaign output characteristic data, and network characteristic data. In other methods, scaling or normalization techniques can be used to map the input parameters into the output characteristic space or vice versa to provide such flattening.

As noted above, some of the input parameter values will not have any performance history data that associates it with some of the existing output characteristic values and vice versa. Accordingly, no data may be available for estimating the performance for some combinations of the delivered invitational content and the existing contexts. Thus, such incomplete data typically limits the usefulness of approaches in which input parameter values are selected based on performance with similar content or in similar contexts. In the various embodiments, the cluster extraction process resolves such issues. In particular, the SVD and the modified extended Fiedler methods described above essentially result in matrices that define the relationship between each of existing output characteristics and each of the sets of input parameter values. Conceptually, the similarity values are used to create a correlation matrix in which the empty or null rank values of the input matrix are populated. As a result, similarity-based estimation of output characteristics can be performed with a high degree of confidence, as a complete set of relationship data is provided.

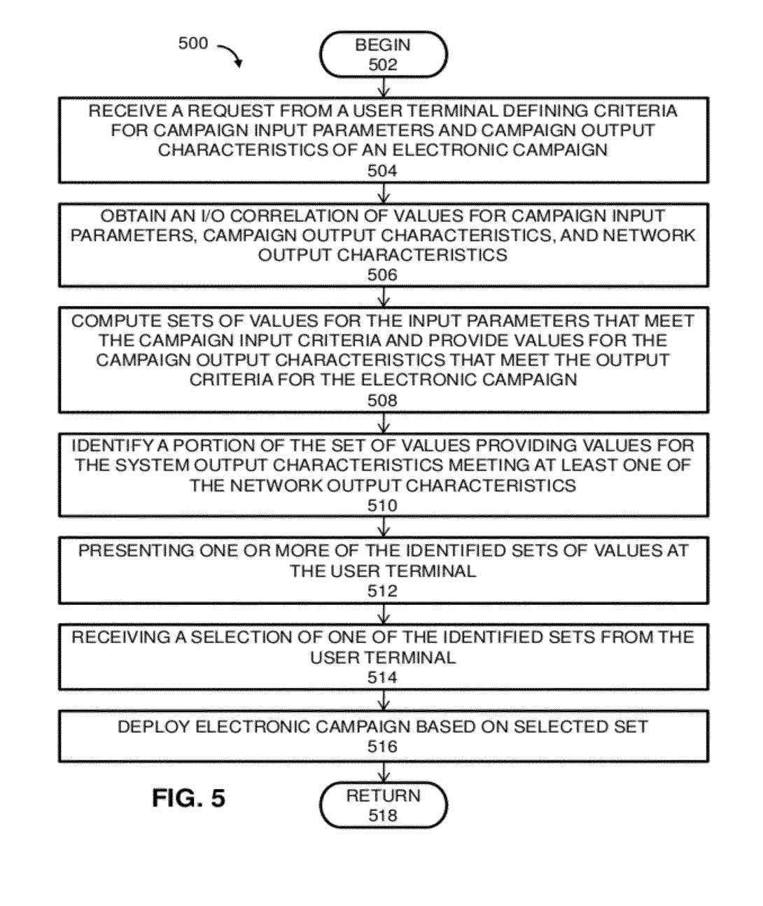

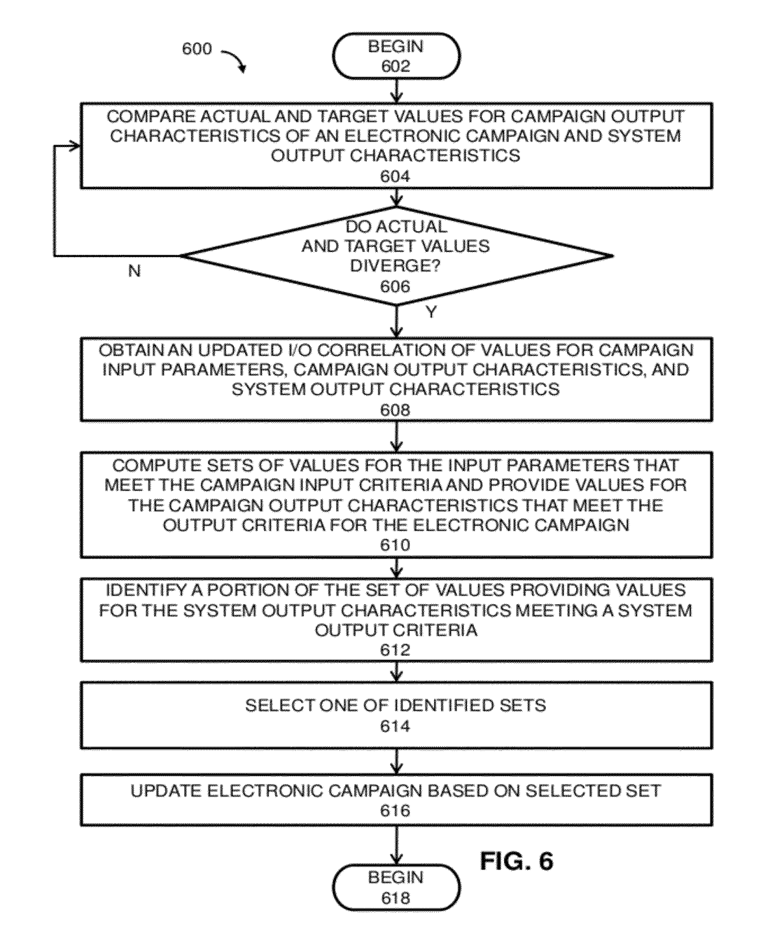

In these configurations, the data export module 406 is operable to define a data set that identifies the sets of campaign input values and corresponding values for the various output characteristics. i.e., an n-way correlation. Further, the data export module 406 generates a relational model or indexing information for the data set, to facilitate lookup of information. Once the dataset is delivered the RDB 224, the request processing module 222 can begin processing requests and generating rules for rules database 216. This process is described in greater detail below with respect to FIGS. 5 and 6.

Referring now to FIG. 5, there is shown a flowchart of steps in an exemplary method 500 for processing requests for an electronic campaign. As shown in FIG. 5, the method begins at step 502 and proceeds to step 504. At step 504, a request for an electronic campaign is received. The request can include information regarding the source and content of the electronic campaign. Further, as described above, the request can also include criteria for selecting values for campaign input parameters and criteria for acceptable values for campaign output characteristics.

Once the request is received at step 504, associated input/output (I/O) correlation data can be obtained at step 506. That is, the request processing module 222 can retrieve information from RDB 224. In some configurations, the retrieved information can include all correlation information computed by database processing module 226. In other configurations, the retrieved data can be limited to correlation data of interest. Specifically the portion of the data in RDB 224 associated with the campaign input parameters, the campaign output parameters, and the network output parameters associated with the requested electronic campaign. Further, this retrieved data can be further limited to the portion of the data in RDB 224 associated with criteria specified in the request and the criteria specified for the network output parameters. In the various embodiments, these criteria are stored separate from the criteria in the request at step 504. In some configurations, these criteria can be centrally stored within content delivery system 206 for all affected network elements. In other configurations, the criteria can be retrieved from each of the affected network elements by the content delivery system 206 in response to receipt of a request.

After the correlation data is obtained at step 506, the data can be used at step 508 to compute one or more sets of values for the campaign input parameters. In particular, the correlation data is used to determine values for the campaign input parameters which meet the criteria specified in the request and provide campaign output characteristics that also meet the criteria specified in the request. For example, as described above, values can be computed based on extrapolation, evaluation of one or more correlation function, etc. The exact methodology for computing the values can vary depending on how the data for the n-way correlation is stored in RDB 224. Afterwards, at step 510, the portion of the values computed at step 508 that also provide values for the network output characteristics, based on the correlation data, are identified.

At step 512, one or more of the identified sets of values can then be presented at the user terminal, along with the resulting, projected campaign output characteristic values. In particular, the sets of values for the campaign input parameters are presented to induce a user associated with the request to select a set that is preferred by the content delivery system, a primary content provider, and/or other network elements affected by the electronic campaign. In the various embodiments, the identified sets of values can be presented in a variety of ways to achieve this goal.

In one configuration, the identified sets of values can presented as a ranked or ordered list based on at least one of the resulting network output characteristic values. For example, in the case of a ranking based on a single one of the resulting network output characteristic values, the ranking can be derived from a comparison of the resulting value to a preferred or target value and thereafter generating a score indicating a proximity to the preferred or target value. Thus, values closer to the preferred or target value can be associated with higher scores and thus higher ranking. In other configurations, such a preferred or target value can be specified along with the criteria for the network output characteristics. In yet configurations, the preferred or target value can be a mean value or other value in the range. However, the various embodiments are not limited in this regard and any other methods for specifying preferred or target values can also be used.

Such preferred or target values can also be used for ranking when more than one network output characteristic value is considered. In such configurations, the ranking can be based on a weighted or unweighted sum of the different scores for each of the network output characteristic values. In the case of a weighted sum, the relative priority of the different network elements defining the network output characteristics can be used to define the weights. Accordingly, scores associated with higher priority network elements can have greater weights as compared to scores associated with lower priority network elements.

In some configurations, at least one of the campaign output characteristics can also be used to rank the sets of values. In such configurations, the ranking can also be based on a weighted or unweighted sum of the different scores for each of the network and campaign output characteristic values. In the case of a weighted sum, the campaign output characteristics can be considered to have a lower priority than the network output characteristics. Accordingly, scores associated with the network output characteristics can have greater weights as compared to scores associated with campaign output characteristics. As a result, even though the campaign output characteristics are considered for the ranking or ordering, the scores associated with the network output characteristics will still be predominant.

When the list of sets of values is presented to the user, the list can be complete or limited. That is, all possible sets of values meeting the various criteria can be presented to the user or only a subset of these values can be presented. In the case of presenting all sets of values, the sets of values can be presented in a ranked order, as described above. In the case of presenting a subset, a portion of these sets can be selected and then presented, in a ranked or unranked order. In either case, selection of the portion of the sets can be performed in several ways. For example, scores can be computed, as described above, and thereafter the sets of values associated with the n highest scores can be selected. In another example, additional selection criteria may be specified, and the sets of values can be the sets of values associated with an electronic campaign that meets the additional criteria. These additional criteria can be related or unrelated to the campaign input parameters, the campaign output characteristics, or the network output characteristics.

Once the sets of values are presented at the user terminal at step 512, a selection of one of the sets can be received at step 514. Thereafter, an electronic campaign can be deployed or booked at step 516, where the electronic campaign is configured using the selected set of values for the campaign input parameters received at step 514. Method 500 can then resume previous processing at step 518, including repeating method 500.

The planning and booking of electronic campaigns is but one aspect of the present technology. As described above, system 200 is a dynamic environment in which the number and types of user terminals 202, primary content providers 210, and secondary content providers 214 can vary over time. As a result, the set of campaign input parameter values used to book an electronic campaign may only be valid for a short time. That is, as the environment of system 200 varies over time, the availability of inventory atoms can vary and the goals and requirements of the various network elements can also vary over time. Further, it is also possible that the goals for the campaign can also vary over time. Accordingly, booked campaigns may need to be adjusted periodically to ensure that the goals of the secondary content provider are still being met. Further, these booked campaigns may need to be adjusted periodically to ensure that the goals of the various network elements affected by the electronic campaign are also still being met. Such a method for updating input parameter values for electronic campaigns is described below with respect to FIG. 6

FIG. 6 is a flowchart of steps in an exemplary method 600 for updating campaign input parameter values for an electronic campaign. Method 600 can be performed at various locations in content delivery system, such as at request processing module 222 or content management module 208. Method 600 begins at step 602 and continues on to step 604. At step 604, a booked campaign can be first evaluated to see if correction or updating is needed. In particular, the actual values for the campaign output characteristics and the network output characteristics are compared to the target values for these characteristics. Such values can be stored in history database 228 or elsewhere in system 200. Thereafter, at step 606, it is determined whether the actual values diverge from the target values.

It is worth noting that the comparison at step 604 can involve looking at criteria for the campaign and system output characteristics that is different than the criteria specified during the booking process. Additionally, the comparison at step 604 can also include looking at criteria associated with other campaign and/or system output characteristics than were considered during the booking processing. Thus the divergence at step 606 can be with respect to new criteria and/or new characteristics of interest. Accordingly, this allows the capture of changes in criteria and/or characteristics of interest over time.

In some configurations, the target values can simply be the criteria specified for the various output characteristics. For example, if the comparisons at step 604 shows that all the actual values still fall within the ranges defined by the various criteria, the values are not considered to diverge at step 606. In some cases, the target values can be allowed to exceed such ranges by some pre-defined amount. For example, excursions of 5%, 10%, 20%, or any other amount can be permitted. Accordingly, the occurrence of such deviations would not be considered diverging at step 606.

However, the various embodiments are not limited in this regard and the target values can be defined in other ways. For example, a single target value can be set for each of the various output characteristics. In another example, ranges different from the ranges in criteria can also be specified.

Additionally, the determination of divergence at step 606 can vary. In the configuration described above, if any of the actual values fail to meet corresponding criteria or are different from a target value, a divergence is detected at step 606. However, in other configurations if one or a few of the actual values fail to meet corresponding criteria or are different from a target value, a divergence will not be detected at step 606. In yet other configurations, a divergence is not detected at step 606 unless at least one of the failing actual values fails the corresponding criteria or is different from a target value by some minimum amount. Any other methods, techniques, or schemes for evaluating divergence can also be used in the present technology.

Regardless of how divergence is evaluated at step 606, if the actual values are not found to diverge at step 606, method 600 can return to step 604. Thus, steps 604 and 606 can be repeated until the actual values are found to diverge at step 606. In some configurations, these steps can be repeated continuously, so that changes in the environment are captured and processed in real-time. However, the various embodiments are not limited in this regard. In other configurations, a delay can be introduced between the evaluation at step 606 and the comparison at step 604. In such configurations, the delay can be any amount of time. For example, the delay can be selected to be a time period typically associated with significant changes in system 200. Such a delay can be selected manually or computed automatically by content delivery system 206. In yet other configurations, the transition from step 606 to step 604 is triggered by some event. For example, content delivery system 206 can be configured to monitor the number and/or types of user terminals 202, primary content providers 210, secondary content providers 214, and/or booked electronic campaigns. Responsive to detecting a change in one or more of these, the transition can be triggered. Further, criteria for generating the trigger can also be provided such that a minimum amount of change is also required to generate the trigger.

If the actual and target values do diverge at step 606, the method 600 can proceed to step 608. At step 608 an updated I/O correlation between the values for the campaign input parameters, the values for the campaign output parameters, and the values for the network output characteristics can be obtained. This updated I/O correlation can be obtained in substantially the same manner as described above with respect to step 506 in FIG. 5. However, at step 608, the additional performance history obtained between booking of the electronic campaign and the comparison at step 604 can also be considered in order to provide an I/O correlation that is up to date.

It is worth noting that step 608 can involve obtaining an I/O correlation associating different ones of the campaign input parameters, the campaign output parameters, and the network output characteristics than originally considered during the booking process. Accordingly, this allows the capture of changes in criteria and/or characteristics of interest over time.

It is further worth noting that during method 600, the additional computations for deriving missing values, as describe above with respect to FIG. 4, may not be required. That is, if the booked campaign has been active for a sufficient length of time, a sufficient number of actual values for the campaign input parameters and the various output characteristics will be available to determine correlations thereof. However, the various embodiments are not limited in this regard and the processes described above can be performed in spite of the availability of data.

After the updated I/O correlation is obtained at step 608, sets of values for the campaign input parameters that meet corresponding criteria and that provide values for the campaign output characteristics that also meet corresponding criteria can computed or identified at step 610. These sets of values can be computed based on the updated I/O correlation in a substantially similar manner as the set of values were computed at step 508 in FIG. 5. Thereafter a portion of the sets of values can be identified at step 612, in particular, a portion of the sets of values that provides network output characteristics that meet corresponding criteria. This identification can be performed in substantially a same manner as the identification at step 510 in FIG. 5.

Once the portion of the sets of values is identified at step 612, one of the identified sets can be selected at step 614. In some configurations, this can involve presenting one or more of the identified sets or values and requesting a secondary content provider to select one of the identified sets of values, as in FIG. 5. However, in other configurations, the selection can be automatic. For example, a ranking can be performed, as described above, for the identified sets of values. Thereafter a highest ranked set of values can be selected. In another example, the secondary content provider can provide instructions on how the one of the identified sets of values is to be selected. For example, the secondary provider can specify a maximum amount of change allowed for any of the input parameter values.

After one of the identified sets is selected at step 614, the booked electronic campaign can be updated at step 616. In particular, a new set of input parameter values is specified for the booked campaigns. Further, new criteria for monitoring the resulting campaign and network characteristic values can also be specified. Thereafter, method 600 can end at step 618 and resume previous processing, including repeating method 600.

In the case of repeating method 600, the time interval between step 618 and step 602 can vary. That is, similar to the transition as described above with respect to steps 604 and 606, the transition between steps 618 and 602 can be immediate or can involve some sort of delay.

In the various embodiments, content delivery system 206 can be configured to permit users to adjust the operation and configuration of the various components of content delivery system 206. Accordingly, a user interface can be provided for communicating with a user interface (UI) module 230 for performing such tasks. Further, the UI module 230 can be configured to provide different levels of access based on authenticating different types of users. For example, administrative users can utilize the user interface and UI module 230 for specifying and/or modifying information regarding the primary content providers 210, the secondary content providers 214, user terminals 202, and end users. Administrative users can also utilize the user interface and UI module 230 for specifying operating parameters for the various interfaces, modules, engines, or databases of content delivery system 206. Further, administrative users can also utilize the user interface and UI module 230 for manually or directly adjusting any of the entries in the databases of content delivery system 206.

In addition to providing access to administrative users, the user interface and UI module 230 can also be configured to provide access to end users associated with primary content providers 210 and end users associated with secondary content providers. In the case of end users associated with primary content providers 210, the user interface and UI module 230 can be configured to allow such end users to, for example, update existing content from primary content providers 210 with the content delivery system 206, register new content or new primary content providers with the content delivery system 206, and/or specify preferences for selecting content from secondary content providers 214. In another example, the user interface and UI module 230 can include analysis tools for evaluating performance of content from the primary content providers 210, such as the performance of content with respect to the user terminals and/or content from the secondary content providers 214. In the case of end users associated with secondary content providers 214, the user interface and UI module 230 can be configured to allow these end users to, for example, update existing content from secondary content providers 214 with the content delivery system 206, register new content or new secondary content providers with the content delivery system 206, or specify preferences for selecting primary content providers 214. In another example, the user interface and UI module 230 can include analysis tools for evaluating performance of content from the secondary content providers 214, such as the performance of content with respect to the user terminals 202 and/or content from the primary content providers 210.

In the various embodiments, the user interface for the UI module 230 can be accessed via an end user terminal in communication with the content delivery system 206. For example, the end user terminal can be one of user terminals 202, a user interface device associated with any of content providers 210 and 214, or any user interface device or system locally or remotely connected to content delivery system 206. The user interface and UI module 230 can be configured to operate in a variety of client modes, including a fat client mode, a thin client mode, or a hybrid client mode, depending on the storage and processing capabilities of the content delivery system 206 and/or the end user terminal. Therefore, a user interface for UI module 230 can be implemented as a standalone application operating at the end user terminal in some embodiments. In other embodiments, web browser-based portal can also be used to provide the user interface for UI module 230. Any other configuration to remotely or locally accessing content delivery system 206 can also be used in the various embodiments.

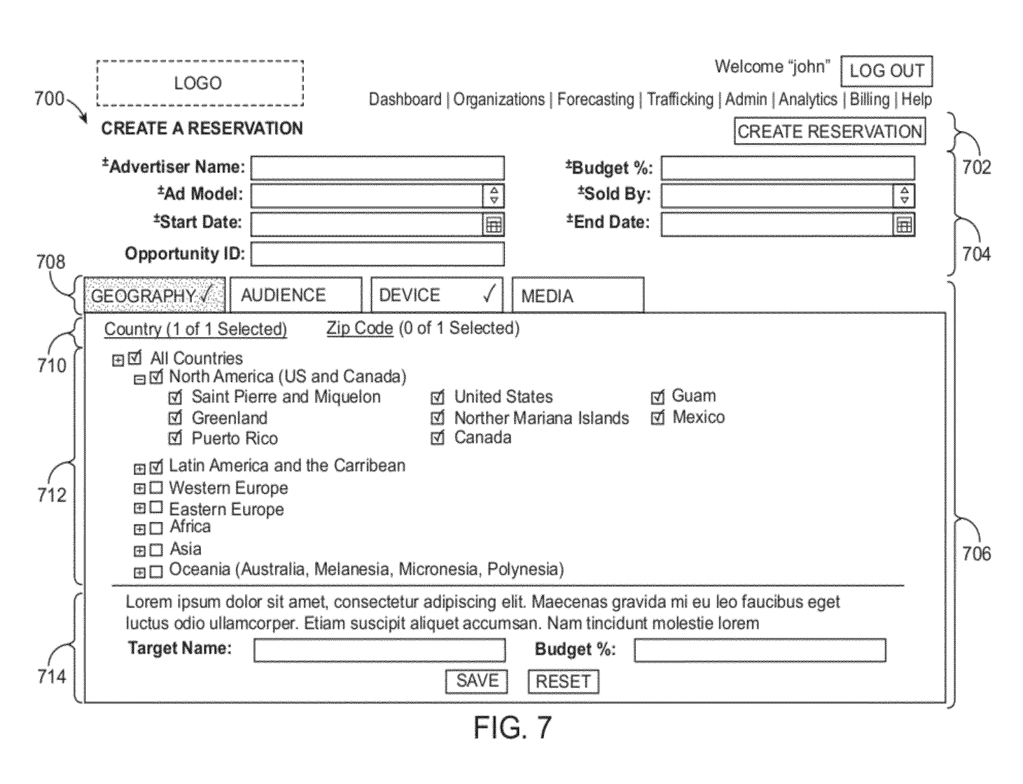

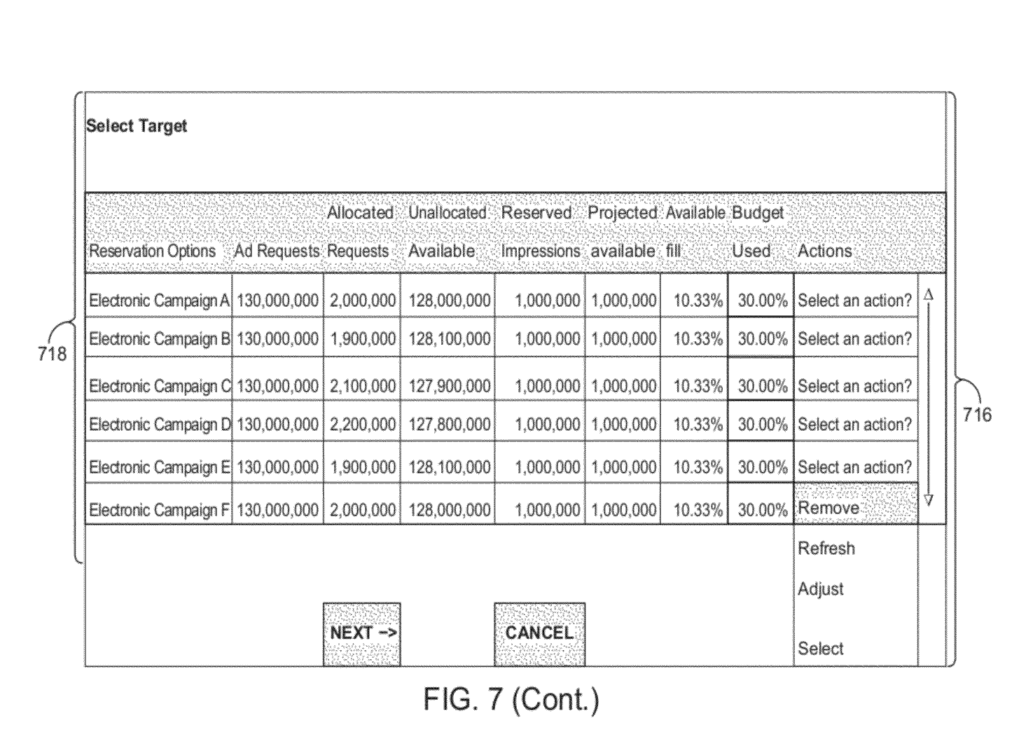

An exemplary configuration for a user interface is described below with respect to FIG. 7. FIG. 7 is a schematic of an exemplary configuration for screen 700 for booking electronic campaigns in accordance with an embodiment of the invention. In the configuration illustrated in FIG. 7, the screen 700 is accessed by a link or other control, such as link 702. Although screen 700 will be described primarily with respect to the creation of new reservations for electronic campaigns, users can also use screen 700 to review and make updates to reservations they have already created. Further, screen 700 can also be used by users in response to a notification from content delivery system or other network element that a change in the electronic campaign is required or advisable.

In a first section 704, a user can input information regarding the advertiser. For example, users can input:

Advertiser Name (e.g., by inputting or selecting name of Advertiser);

Ad Model (e.g., by selecting from a list of ad model types);

Sold by (e.g., by selecting from a list of Assignees);

Start Date (e.g., by selecting from a calendar pop-up panel);

End Date (e.g., by selecting from a calendar pop-up panel);

Budget (e.g., by inputting an amount or other values); and

Opportunity ID: Salesforce ID #.

In a second section 706, a user can input inventory atom target information (i.e., the inventory slot of interest). In the configuration shown in FIG. 7, presence of a selection is indicated by checkmarks or other indicia at various points in section 706, as described below. Section 706 can include various portions. As shown in FIG. 7, section 706 includes a top level navigation link or tabs 708 for accessing a selection screen for selecting atoms associated with each of the tabs 708. For example, the tabs 708 can be used to categorize atom selection by Geography, Audience, Device, or Media. As described above and as shown in FIG. 7, a checkmark or other indicia can be used to indicate selection of atoms associated with each of these tabs 708.

For each of tabs 708, section 706 can also include an interface for selection of segment characteristics for the inventory atoms. In the exemplary configuration shown in FIG. 7, the various characteristics can be categorized and accessed in several ways. In FIG. 7, segment characteristics are associated with sub-level navigation links 710 for each of the tabs 708. The link 710 can be selected to access different groups of segment characteristics within each of tabs 708. Similar to tabs 708, the links 710 can be configured to include indicia of the user's selections associated with one or more of the links. For example, as shown in FIG. 7, the link can indicate the number of segment characteristics selected: “Spending Levels (3 of 6 selected)”. Selection of segment characteristics can then be performed using options 712, as shown in FIG. 7. In FIG. 7, the options 712 are a hierarchy of collapsible selection checkboxes.

In the present technology, the number and arrangement of tabs 708, links 710, and options 712 can vary according to the various segment characteristics available and the categorization provided. One exemplary configuration of tabs and links leading to selectable options is shown below:

Geography:

Country
Zip Code

Audience:

Demographics

Age Group
Gender
Income
Ethnicity
Life Stage
Marital Status

Preferences

Apps
Movies
Music
TV
Books

Spending Levels

Apps
Movies
Music
TV
Books

Frequency

Apps
Movies
Music
TV
Books

Device:

Devices

Carrier
Devices
Models
OS Name

Media:

Media Types

App Category
Content Rating
Section
Placement
Media Type
Content Exclusions
Day Parting
DOW (Day of Week)

An exemplary configuration for a user interface for displaying portion 706 further includes a section 714 for creating a name for the target generated via the selections in sections 708, 710, and 712. This target name can then be used to subsequently identify the target in other portions of the user interface. Additionally, section 714 can also specify a portion for identify an amount or a portion of the user's budget to be used for the target inventory atoms. Finally, section 714 can include a link or control for saving and/or clearing the information entered by the user in section 706.

Screen 700 can also be configured to include a target information section 716. Section 716 can include a campaign/reservation options portion 718 that displays a table of the campaign options based on the target and budget options specified by the user in portion 706. Thus, when a target is saved in section 706, portion 718 is generated. Each of the rows in portion 718 can represent a different proposal for an electronic campaign that meets the user's criteria and criteria for network output characteristics, as described above. Further, as also described above, these proposed electronic campaigns can be listed in an order based on at least on the network output characteristics. That is, the proposed campaigns can be ranked according to the network output characteristics or limited to those electronic campaigns associated with network output characteristics meeting a criteria.

Each row of information can be configured to display information about each of the campaign/reservation options. In the exemplary configuration of FIG. 7, portion 718 is configured with the following columns:

Reservation option (Identifier for options);

Ad Requests (Total projected number of requests for the atoms associated with the saved target);

Allocated Requests (Total number of requests for atoms that are already queued for fulfillment by content delivery system);

Unallocated available (=Ad Requests−Allocated Requests);

Reserved impressions (Atoms reserved by content delivery system but not committed for any campaign);

Projected Available (=Requests−Unallocated−Reserved);

Available Fill; and

Budget Used (Amount for budget projected to be used for target).

In addition to the information columns, portion 718 can also include an Action Column for managing the list of proposed campaigns. For example, a “Remove” action can be provided to allow the user to remove a proposed reservation from the list. In some cases, this can result in portion 718 being automatically updated to add a next highest ranked, but not previously shown proposed campaign. In another example, a “Refresh” action can be provided to update the information for the proposed campaign. In yet another example, an “Adjust” action can be provided to allow the proposed campaign to be individually adjusted by the user. Finally, a “Select” action can be provided for the user to select the campaign of interest.

Additionally, links can be provided to allow users to jump to different portions of screen 700 or other screens. For example, a “NEXT” link can be provided in section 716 that moves a current view or focus of screen 700 to a next portion or moves to a next screen for finalizing a selected reservation from portion 718. Also, a “CANCEL” link can be provided to clear the current information in sections 704 and 706 to allow the user to input new information or start over.

Although the user interface and UI interface 230 are described above as providing specific types of functionality for specific types of end users, the user interface and UI module 230 can also be configured to allow other interactions between end users and the content delivery system 206.

For example, the user interface and UI module 230 can be used to specify any of the parameters, weights, or any other variables for the systems and methods described herein. In another example, the user interface can also be user to view, analyze, and/or modify any final or intermediate results or data generated by any of the systems and methods described herein. In yet another example, the user interface and UI module 230 can also provide a reporting/analysis interface area designed for mining/analyzing performance of content from the secondary providers in terms of CTR, eCPM, cost measures, revenue measures, etc. Additionally, UI module 230 can be configured to sends notifications and alerts to users associated with primary content providers 210 (via email, messaging, etc.) when a campaign runs low, a budget runs low, or any other event of interest occurs. Additionally, the UI module 230 can also send daily/weekly/monthly reports of campaign delivery performance and suggestions for optimization to the content providers 210 and 214.

Other implementations according to these examples include non-transitory computer-readable media for carrying or having computer-executable instructions or data structures stored thereon. Such computer-readable media can be any available media that can be accessed by a general purpose or special purpose computer. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions or data structures.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed as limiting. Those skilled in the art may recognize various modifications and changes that may be made while following the example embodiments and applications illustrated and described herein, and without departing from the true spirit and scope of the present disclosure.

1. A method, comprising:
receiving a request for managing an electronic campaign, the request comprising a first criteria for one or more campaign input parameters for the electronic campaign and a second criteria for one or more campaign output characteristics for the electronic campaign;
computing one or more sets of values for the campaign input parameters meeting the first and the second criteria based on an input/output (I/O) correlation defining a relationship between values for the campaign input parameters, values for the campaign output characteristics, and values for one or more network output characteristics for the electronic campaign; and
providing at least a portion of the computed sets of values at the user terminal, the portion of the computed sets of values presented in an order based on at least one of the network output characteristics.

2. The method of claim 1, wherein the step of providing comprises selecting the order to be further based on at least one of the campaign output characteristics.

3. The method of claim 1, wherein the network output characteristics are associated with a plurality of entities associated with delivery of invitational content for the invitational content provider, and wherein the step of providing further comprises selecting the order to be based on a relative priority of each of the plurality of entities.

4. The method of claim 1, wherein the step of providing further comprises:
defining a third criteria for the network output characteristics; and
selecting the order to be based on a degree of matching between the third criteria and the values for the network output characteristics provided by the portion of the computed sets of values.

5. The method of claim 4, wherein the third criteria comprises one of a revenue criteria or a cost criteria for one or more other network elements associated with delivery of invitational content for the invitational content provider.

6. A system, comprising:
a communications interface for receiving requests from one or more user terminals associated with a plurality of invitational content providers, each of the requests comprising a first criteria for one or more campaign input parameters for an electronic campaign and a second criteria for one or more campaign output characteristics for the electronic campaign; and
a request processing element, wherein responsive to each of the received requests, the request processing element is configured for assembling an input/output (I/O) correlation defining a relationship between values for the campaign input parameters, values for the campaign output characteristics, and values for one or more network output characteristics, computing one or more sets of values for the campaign input parameters meeting the first and second criteria based the I/O correlation, and for causing the communications interface to transmit at least a portion of the computed sets of values to the user terminal, wherein an order of the transmitted portion of the computed sets of values is based on at least one of the network output characteristics.

7. The system of claim 6, wherein the request processing element is further configured for computing the order based on at least one of the campaign output characteristics.

8. The system, of claim 6, wherein the network output characteristics are associated with a plurality of entities associated with delivery of invitational content for the invitational content provider, and wherein the processing element is further configured for computing the order based on a relative priority of each of the plurality of entities.

9. The system of claim 6, wherein the processing element is further configured for computing the order based on a degree of matching between a third criteria for the network output characteristics and the values for the network output characteristics provided by the portion of the computed sets of values.

10. The system of claim 9, wherein the third criteria comprises one of a revenue criteria or a cost criteria for one or more other network elements associated with delivery of invitational content for the invitational content provider.

11. A method of managing electronic campaigns, comprising:
detecting a divergence between actual and requested values for at least among one or more campaign output characteristics associated with an electronic campaign and one or more network output characteristics associated with the electronic campaign;
assembling an input/output (I/O) correlation defining a relationship between values for campaign input parameter for the electronic campaign, values for the campaign output characteristics, and values for the network output characteristics;
computing one or more sets of values for the campaign input parameters that meet a first criteria and provide values for the campaign output characteristics that meet a second criteria based the I/O correlation; and
adjusting the electronic campaign based on one of the set of values.

12. The method of claim 11, wherein the step of adjusting further comprises:
selecting a one of the sets of values meeting a third criteria; and
modifying the campaign input parameters based on the selected one of the sets of values.

13. The method of claim 12, wherein the step of selecting further comprises:
providing at least a portion of the computed sets of values to a user terminal associated with the electronic campaign, the portion of the computed sets of values presented in an order based on at least one of the network output characteristics.

14. The method of claim 13, wherein the step of providing comprises selecting the order to be further based on at least one of the campaign output characteristics.

15. The method of claim 13, wherein the network output characteristics are associated with a plurality of entities associated with delivery of invitational content for the invitational content provider, and wherein the step of providing further comprises selecting the order to be based on a relative priority of each of the plurality of entities.

16. A non-transitory computer-readable medium having code for causing a computer to perform a method stored thereon, the method comprising:
receiving a request for managing an electronic campaign from a user terminal associated with an invitational content provider, the request comprising a first criteria defining one or more campaign input parameters for the electronic campaign and a second criteria defining one or more campaign output characteristics for the electronic campaign;
obtaining an input/output (I/O) correlation defining a relationship between values for the campaign input parameters, values for the campaign output characteristics, and values for one or more network output characteristics;
computing one or more sets of values for the campaign input parameters meeting the first and second criteria based the I/O correlation; and
communicating a portion of the computed sets of values at the user terminal associated with values for the network output characteristics meeting a third criteria.

17. The computer-readable medium of claim 16, wherein the step of communicating further comprises providing the portion of the sets of values in an order based on at least one of the network output characteristics.

18. The computer-readable medium of claim 16, wherein the network output characteristics are associated with a plurality of entities, and wherein the step of communicating further comprises providing the portion of the sets of values in an order based on a relative priority of each of the plurality of entities.

19. The computer-readable medium of claim 16, wherein the step of communicating further comprises providing the portion of the sets of values in an order based on a matching between the values for the network output characteristics and the third criteria.

20. The computer-readable medium of claim 16, wherein the third criteria comprises one of a revenue criteria or a cost criteria of one or more entities other than the invitational content provider.

21. A content delivery system, comprising:
a processing element;
a first module for causing the processing element to retrieve requests for managing electronic campaigns from one or more user terminals associated with invitational content providers, each of the requests comprising a first criteria defining one or more campaign input parameters for the electronic campaign and a second criteria defining one or more campaign output characteristics for the electronic campaign;
a second module for causing the processing element to obtain an input/output (I/O) correlation for the requests, the I/O correlation defining a relationship between values for the campaign input parameters, values for the campaign output characteristics, and values for one or more network output characteristics; and
a third module for causing the processing element to deliver responses to the user terminals, each of the responses comprising one or more sets of values for the campaign input parameters generated based on the correlation, wherein the sets of values are generated to meet the first criteria, the second criteria, and a third criteria for the network output characteristics.

22. The system of claim 21, wherein the third module is further configured for causing the processing to deliver the portion of the sets of values in an order based on one or more characteristics selected from at least one of the campaign output characteristics and the network output characteristics.

23. The system of claim 21, wherein the network output characteristics are associated with a plurality of entities, and wherein the third module is further configured for causing the processing element deliver the portion of the sets of values in an order based on a relative priority of the plurality of entities.

24. The system of claim 21, wherein the third module is further configured for causing the processing element to deliver the portion of the sets of values in an order based on a difference between the values for the network output characteristics and the third criteria.

25. The system of claim 21, wherein the third criteria comprises one of a revenue criteria or a cost criteria of one or more entities other than the invitational content provider.
